(19) United States
(12) Patent Application Publication
(10) Pub. No.: US 2006/0186226 A1
(43) Pub. Date: Aug. 24, 2006

(54) Fuel injector for internal combustion engines

(76) Inventor: Friedrich Boecking, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/538,031

(22) PCT Filed: May 13, 2004
(86) PCT No.: PCT/EP04/50785

§ 371 Date: Jun. 8, 2005

(30) Foreign Application Priority Data
Jun. 10, 2003 (DE) 10326044.7

(51) Int. Cl. F02M 63/00

(52) U.S. Cl. 239/533.2

(57) ABSTRACT

A fuel injector for an internal combustion engine, with an injector body having at least one first injection orifice and at least one second injection orifice a hollow first nozzle needle guided in a first needle guide of the injector body and controlling the injection of fuel through the at first injection orifice(s), and having a second nozzle needle disposed coaxial to the first nozzle needle and controlling the injection of fuel through the at least one second injection orifice. The first nozzle needle is provided with a first catch contour which, once the first nozzle needle opens a predetermined preliminary stroke cooperates with a second catch contour on the second nozzle needle and when the opening movement of the first nozzle needle exceeds the preliminary stroke carries the second nozzle needle along with it.

### PRIOR ART

The present invention relates to a fuel injector for internal combustion engines with the characteristics of the preamble to claim 1.

A fuel injector of this kind is known, for example, from DE 100 58 153 A1, and has an injector body that has at least one first injection orifice and at least one second injection orifice. A first needle guide of the injector body guides a first nozzle needle embodied in the form of a hollow needle, which controls the injection of fuel through the at least one first injection orifice. The first nozzle needle contains a second nozzle needle coaxial to it, which can control the injection of fuel through the at least one second injection orifice. In the known fuel injector, the second nozzle needle is drive-connected to a drive piston, which, inside a control chamber, has a control surface that acts in the closing direction when subjected to pressure. The second nozzle needle has a pressure shoulder, i.e. a cross-sectional area of a second valve seat provided between the second nozzle needle and the injector body is smaller than a cross-sectional area of a second needle guide provided inside the first nozzle needle to guide the second nozzle needle. When the first nozzle needle is open, the pressure shoulder of the second nozzle needle is subjected to pressure, which causes the pressure shoulder of the second nozzle needle to act in the opening direction. When the first nozzle needle is open, if the second nozzle needle should also be opened, then the pressure in the control chamber can be reduced so that the opening force acting on the pressure shoulder of the second nozzle needle predominates. The complexity required to actuate the second nozzle needle in this connection is relatively high.

### ADVANTAGES OF THE INVENTION

The nozzle needle according to the present invention, with the characteristics of the independent claim, has the advantage of the prior art that the actuation of the second nozzle needle does not require control of the pressure prevailing in a separate control chamber. The present invention is based on the general idea of providing a mechanical catch for actuation of the second nozzle needle, which couples the stroke motion of the first nozzle needle to a stroke motion of the second nozzle needle once the first nozzle needle has traveled a predetermined preliminary stroke. The present invention thus controls the opening of the second nozzle needle as a function of the opening stroke of the first nozzle needle. When the first nozzle needle opens, the second nozzle needle remains closed until the opening stroke of the first nozzle needle reaches the predetermined preliminary stroke. Once this preliminary stroke is reached, the first nozzle needle can then carry the second nozzle needle along with it, as a result of which, the second nozzle needle also opens. The opening stroke of the first nozzle needle can be controlled in the usual way by means of a corresponding actuator, in particular a piezoelectric actuator. In this connection, the opening times and an interval between the opening point of the first nozzle needle and the opening point of the second nozzle needle can be varied almost infinitely. It is thus possible to trigger the two nozzle needles to open one after the other using a single actuator. This considerably reduces the complexity required to implement a triggering of the second nozzle needle.

According to a particularly advantageous embodiment, the second nozzle needle can be designed without a pressure shoulder. In this design, the cross-sectional area in the sealing seat of the second nozzle needle corresponds to the cross-sectional area of a second needle guide provided for the second nozzle needle. As a result of this design, the compressive forces acting on the second nozzle needle in the opening direction do not change with the opening of the first nozzle needle. Furthermore, when the first nozzle needle is open, no (hydraulic) compressive forces acting in the opening direction are exerted on the end of the second nozzle needle oriented toward the injection orifices. This design simplifies the assembly of the fuel injector.

In a modification, the end of the second nozzle needle oriented away from the injection orifices can be disposed in a first leakage chamber; a second spring then prestresses the second nozzle needle in the closing direction. The leakage chamber is usually relatively unpressurized so that essentially, only the second spring acts on the second nozzle needle in the closing direction. Particularly in connection with the elimination of the pressure shoulder on the second nozzle needle, a relatively small amount of force is therefore sufficient to open and close the second nozzle needle. This is particularly advantageous for the mechanical coupling provided, since it can reduce the occurrence of wear.

Catch contours, which are formed onto the nozzle needles and produce the desired mechanical positive coupling between the nozzle needles once the preliminary stroke has been reached, can be suitably disposed so that they cooperate with each other inside the first leakage chamber. As a result, a relatively low ambient pressure prevails in the region surrounding the catch contours, which promotes proper functioning of these catch contours.

Other important characteristics and advantages of the fuel injector according to the present invention ensue from the dependent claims, the drawings, and the associated description of the figures taken in conjunction with the drawings.

### DRAWINGS

Exemplary embodiments of the fuel injector according to the present invention are shown in the drawings and will be explained in greater detail in the subsequent description; components that are the same, similar, or functionally equivalent have been provided with the same reference numerals.

FIGS. 1 to 3 schematically depict very simplified longitudinal sections through fuel injectors in different embodiment forms.

### DESCRIPTION OF THE EXEMPLARY EMBODIMENTS

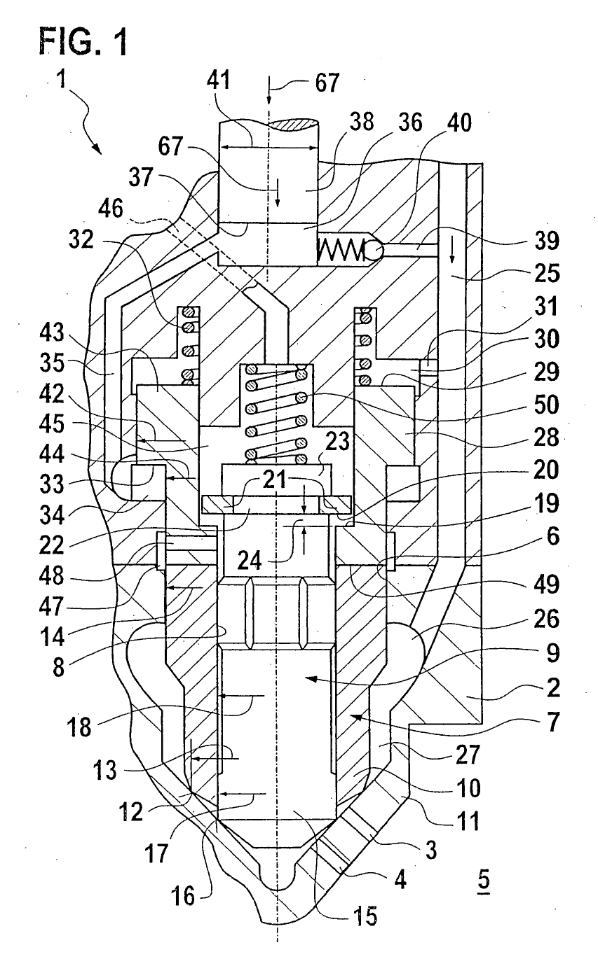

As shown in FIG. 1, a fuel injector 1 according to the present invention has an injector body 2. The injector body 2 is equipped with at least one first injection orifice 3 and at least one second injection orifice 4, which feed into a combustion chamber or premixing chamber 5 of an internal combustion engine that is not shown in greater detail. Usually, several first injection orifices 3 and/or several second injection orifices 4 are provided.

The injector body 2 includes a first needle guide 6 that contains a first nozzle needle 7, which is supported so that it can execute a stroke motion. The first nozzle needle 7 is embodied as a hollow needle and includes a second needle guide 8 that contains a second nozzle needle 9, which is supported so that it can execute a stroke motion. The second nozzle needle 9 is disposed coaxial to the first nozzle needle 7.

Between a first needle tip 10 oriented toward the injection orifices 3, 4, and an injector tip 11 containing the injection orifices 3, 4, an annular first sealing seat 12 is provided, which is disposed upstream of the first injection orifices 3. The cross-sectional area 13 in the first sealing seat 12 here is smaller than the cross-sectional area 14 of the first needle guide 6, as a result of which, the first nozzle needle 7 has a pressure shoulder. Arrows indicate the respective cross sections 13, 14.

In addition, between a second needle tip 15 of the second nozzle needle 9 oriented toward the injection orifices 3, 4 and the injector tip 11, a second sealing seat 16 is provided, which is disposed between the at least one first injection orifice 3 and the at least one second injection orifice 4. By contrast with the first nozzle needle 7, the second nozzle needle 9 in the embodiment form shown here does not have a pressure shoulder, i.e. the cross-sectional area 17 of the second sealing seat 16 is the same size as the cross-sectional area 18 of the second needle guide 8.

Because of the selected position of the sealing seats 12, 16, the first nozzle needle 7 can control the at least one first injection orifice 3, while the second nozzle needle 9 can control the at least one second injection orifice 4.

According to the present invention, the first nozzle needle 7 is then provided with a first catch contour 19, which is embodied here in the form of an annular step. The second nozzle needle 9 is provided with a second catch contour 20 that corresponds to the first catch contour 19. The second catch contour 20 can also be comprised of a correspondingly embodied annular step. In the embodiment form shown here, at least two radially protruding steps 21 are provided to constitute the second catch contour 20 and are inserted into a lateral bore 22 at an end 23 of the second nozzle needle 9 oriented away from the second needle tip 15. The catch contours 19, 20 can also be embodied with other suitable designs.

In the starting position shown in FIG. 1, both of the nozzle needles 7, 9 are closed. The catch contours 19, 20 are disposed so that in the closed position of the two nozzle needles 7, 9, there is a space 24 in the stroke direction between the two catches 19, 20. This space 24 is also referred to below as the preliminary stroke 24.

The injector body 2 also contains a supply line 25, which supplies highly pressurized fuel to the injection orifices 3, 4. The supply line 25 usually comes from a high-pressure accumulator, not shown here, which is supplied by a corresponding high-pressure pump, the so-called “common rail” principle. The supply line 25 in the injector body 2 leads to a nozzle chamber 26 from which the fuel injectors 3, 4 are supplied with fuel via an annular chamber 27.

The injector body 2 also contains a booster piston 28, which is supported so that it can execute a stroke motion. This booster piston 28 is usually a component of the first nozzle needle 7 and/or the booster piston 28 is at least coupled to the first nozzle needle 7 in order to transmit tensile and compressive forces in the stroke direction. The booster piston 28 has a first surface 29, which is disposed in a compensator chamber 30 and is subjected to the pressure prevailing therein. The compensator chamber 30 communicates with the supply line 25 via a bore 31 so that normally, the high fuel pressure prevails in the compensator chamber 30. In the region of the compensator chamber 30, a first spring 32 is also provided, one end of which rests against the injector body 2 and the other end of which rests against the booster piston 28; the first spring 32 prestresses the booster piston 28 and therefore the first nozzle needle 7 in the closing direction. Since the first surface 29 is oriented away from the first needle tip 10, the first surface 29 acts on the first nozzle needle 7 in the closing direction when subjected to pressure.

The booster piston 28 here does not have to be connected to the first nozzle needle 7 because the pressure shoulder of the first nozzle needle 7 on the one hand and the prestressing force of the first spring 32 combined with the compressive forces in the compensator chamber 30 on the other hand counteract each other so that the booster piston 28 and the first nozzle needle 7 can rest against each other axially at a dividing point 49 without being directly connected to each other. The first nozzle needle 7 and the booster piston 28 do nevertheless constitute a functional unit whose constituent components 7, 28 are synchronously set into a shared stroke motion.

The booster piston 28 also has a second surface 33, which is disposed in a first control chamber 34 and can be subjected to pressure therein. Since the second surface 33 is oriented toward the first needle tip 10, the second surface 33 acts on the first nozzle needle 7 in the opening direction when subjected to pressure. The first control chamber 34 communicates with a second control chamber 36 via a control conduit 35. A third surface 37 is disposed in this second control chamber 36 and can be subjected to pressure. This third surface 37 is provided on an actuator piston 38 that is drive-connected to a control element or actuator, which can in particular be embodied as a piezoelectric actuator.

The second control chamber 36 is connected to the supply line 25 via an inlet conduit 39; the inlet conduit 39 contains an inlet valve 40. This inlet valve 40 can, for example, be embodied as a check-type shut-off valve that opens toward the second control chamber 36 and closes toward the supply line 25.

Between the actuator piston 38 and the booster piston 28, there can be a boosting ratio that affects the forces acting on them. The relation of the third surface 37 to the second surface 33 yields the boosting ratio. In the current instance, the third surface 37 corresponds to the cross-sectional area 41 of the actuator piston 38, while the second surface 33 is a result of the cross-sectional area 42 of the booster piston 28 at an end 43 of the first nozzle needle 7 oriented away from the first needle tip 10 minus the cross-sectional area 44 of the booster piston 28 in a section adjoining the end 43 in the region of the second surface 33.

As explained further above, the booster piston 28 and the first nozzle needle 7 together constitute a common unit that can be set into a shared stroke motion. In the current embodiment form, the first catch contour 19 of the first nozzle needle 7 is embodied on the booster piston 28. The end 23 of the second nozzle needle 9 oriented away from the second needle tip 15 is preferably disposed in a first leakage chamber 45. The first leakage chamber 45 is connected to a relatively unpressurized reservoir via a leakage line 46. In the stroke direction between the nozzle chamber 26 and the first control chamber 34, there is a second leakage chamber 47, which communicates with the first leakage chamber 45 via at least one bore 48. Leaks that occur between the outer circumference of the first nozzle needle 7 and the first needle guide 6 can drain into this second leakage chamber 47.

A second spring 50 prestresses the second nozzle needle 9 in the closing direction. One end of the second spring 50 rests against the injector body 2 and the other end rests against the end 23 of the second nozzle needle 9 oriented away from the injection orifices 3, 4. The second spring 50 is thus contained in the first leakage chamber 45. The catch contours 19, 20 are also contained in the first leakage chamber 45.

The fuel injector 1 according to the embodiment form in FIG. 1 functions as follows:

In the starting position shown in FIG. 1, the high pressure that prevails in the supply line 25 and in the nozzle chamber 26 also prevails in the control chambers 34 and 36 and in the compensator chamber 30.

In order to permit a fuel injection to occur through the at least one first injection orifice 3, the actuator piston 38 executes a stroke that reduces the volume of the second control chamber 36. The stroke motion executed by the actuator piston 38 to open the nozzle needles 7, 9 is symbolized in FIG. 1 by an arrow 67.

This opening stroke of the actuator piston 38 increases the pressure in the second control chamber 36. This pressure travels into the first control chamber 34 via the control conduit 35. As a result, the booster piston 28 executes an opening stroke; the booster piston 28 carries the first nozzle needle 7 along with it and/or the first nozzle needle 7 is driven in the opening direction by means of its pressure shoulder and follows the booster piston 28. In other words, the balance of forces acting on the unit comprised of the first nozzle needle 7 and booster piston 28 produces a resultant force acting in the opening direction. This means that the first nozzle needle 7 executes an opening movement in which the first needle tip 10 lifts away from the first sealing seat 12 so that the at least one first injection orifice 3 is connected to the nozzle chamber 26 and can inject fuel into the combustion chamber 5 or premixing chamber 5.

As long as the opening movement of the first nozzle needle 7 is less than the preliminary stroke 24, the second nozzle needle 9 remains in its closed position. But as soon as the opening movement of the first nozzle needle 7 reaches the preliminary stroke 24, then the catch contours 19, 20 come into contact or engage with each other.

If the at least one first injection orifice 3 is insufficient for the desired injection of fuel and fuel should also be injected by means of the at least one second injection orifice 4, then the actuator is triggered to execute an additional stroke movement of the actuator piston 38. When an opening movement of the first nozzle needle 7 exceeds the preliminary stroke 24, therefore, the first nozzle needle 7 brings the second nozzle needle 9 along with it due to the positive coupling of the cooperating catch contours 19, 20, as a result of which the second needle tip 15 lifts away from the second sealing seat 16. When the second nozzle needle 9 is open, then the at least one second injection orifice 4 also communicates with the nozzle chamber 26 and can thus inject fuel into the chamber 5.

Since the second nozzle needle 9 does not have a pressure shoulder, the forces that the first nozzle needle 7 must exert in order to bring the second nozzle needle 9 along with it are relatively low since it is essentially only necessary to overcome the closing force of the second spring 50.

When the injection process is to be terminated, the actuator is triggered to retract the actuator piston 38. As a result, the pressure in the control chambers 34 and 36 drops at least to the pressure in the supply line 25. But the pressure can also fall lower since the inlet valve 40 also produces a pressure drop. As soon as the closing forces predominate, the first nozzle needle 7 is driven back in the closing direction. When the first nozzle needle 7 is closed, the second nozzle needle 9 is unpressurized at the second needle tip 15 so that then at the latest, the closing force of the second spring 50 also closes the second nozzle needle 9.

In the fuel injector 1 according to the present invention, the adjustable stroke of the actuator piston 38 can thus be used to adjust the stroke of the first nozzle needle 7. The opening stroke of the first nozzle needle 7 can also be used to trigger the second nozzle needle 9 to open. The actuation of the two nozzle needles 7, 9 can therefore be achieved with only a single actuator, which means that the fuel injector 1 according to the present invention is particularly inexpensive to manufacture.

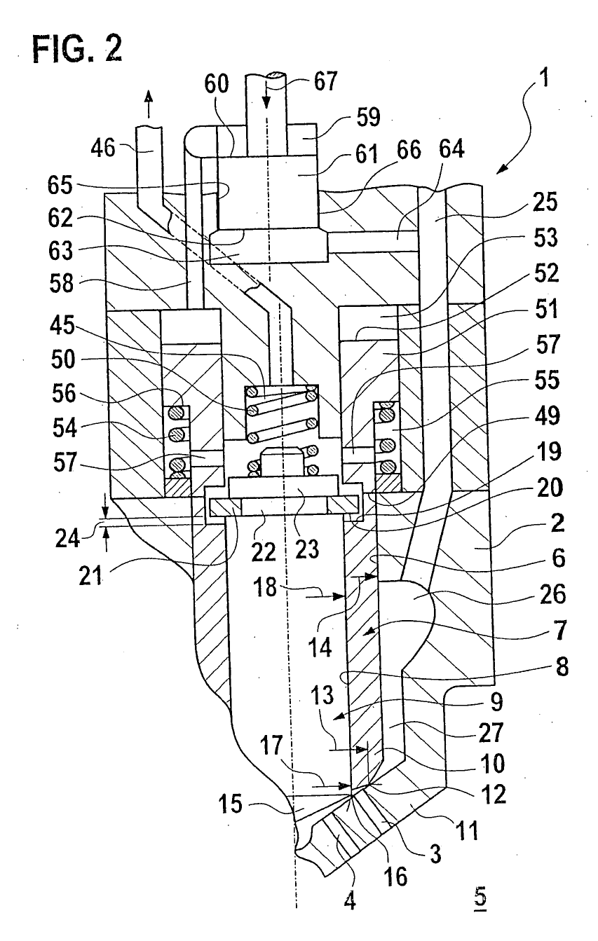

FIG. 2 shows a second exemplary embodiment of the fuel injector 1 according to the present invention. With regard to components and functions that correspond to those in the first exemplary embodiment, reference is hereby made to the relevant statements regarding FIG. 1, so as to limit the discussion below to merely explaining the differences in relation to the exemplary embodiment according to FIG. 1.

As shown in FIG. 2, in this exemplary embodiment as well, the first nozzle needle 7 is driven by a booster piston 51, which can be a component of the first nozzle needle 7 or can at least form a unit with it that can be driven into a shared stroke motion. The booster piston 51 has a first surface 52, which is disposed in a first booster chamber 53 and can be subjected to a pressure therein. The first surface 52 is oriented away from the first needle tip 10 so that it acts on the first nozzle needle 7 in the closing direction when subjected to pressure. In this embodiment form, a first spring 54 prestresses the booster piston 51 in the opening direction of the first nozzle needle 7. The first spring 54 here is contained in a second leakage chamber 55 disposed outside the booster piston 51 and rests against the injector body 2 at one end and against a step 56 on the booster piston 51 at the other end. The second leakage chamber 55 communicates with the inner first leakage chamber 45 via at least one bore 57.

The first booster chamber 53 communicates with a second booster chamber 59 via a booster conduit 58. This second booster chamber 59 contains a return stroke surface 60 of a control piston 61 and can be subjected to a pressure. The return stroke surface 60 is oriented away from the injection orifices 3, 4. The control piston 61 also has a forward stroke surface 62, which is oriented toward the injection orifices 3, 4, is disposed in a control chamber 63, and can be subjected to a pressure. The control chamber 63 communicates with the supply line 25 via a bore 64. As a result of the position selected for it, the control piston 61 separates the second booster chamber 59 from the control chamber 63. This separation is embodied so that a throttle path 66 is provided, which is disposed radially between the control piston 61 and a control piston guide 65, thus allowing the second booster chamber 59 to communicate (in a throttled manner) with the control chamber 63 via the throttle path 66. In static states or during relatively slow movements, the throttle path 66 permits a pressure compensation to occur between the control chamber 63 and the second booster chamber 59 so that in the second booster chamber 59 and thus also in the first booster chamber 53, the same pressure therefore prevails as in the control chamber 63 and thus in the supply line 25. In dynamic states, i.e. during relatively rapid stroke motions of the control piston 61, the pressure compensation between the control chamber 63 and the second booster chamber 59 via the throttle path 66 cannot occur rapidly enough, so that the control piston 61 can produce overpressures and underpressures in the second booster chamber 59 in relation to the control chamber 63.

The fuel injector 1 according to the present invention according to the embodiment form in FIG. 2 functions as follows:

In the starting position according to FIG. 2, both of the nozzle needles 7, 9 are closed. The same pressure prevails in the first booster chamber 53, the second booster chamber 59, and the control chamber 63, as in the supply line 25. In this state, a resultant force acts on the first nozzle needle 7 in the closing direction. The second nozzle needle 9 is relatively unpressurized in the region of its second needle tip 15, which allows second spring 50 for closing the second nozzle needle 9 to be embodied with a relatively low restoring force.

If an injection is now to be carried out by means of the at least one first injection orifice 3, then a corresponding actuator is triggered to execute a stroke actuation of the control piston 51. This stroke motion is oriented toward the injection orifices 3, 4 and is once again indicated by the arrow 67.

With this movement, the volume of the second booster chamber 59 increases, as a result of which the pressure therein decreases. This pressure decreased travels into the first booster chamber 53, thus changing the balance of forces acting on the first nozzle needle 7. As soon as the forces of the first spring 54 and the pressure shoulder of the first nozzle needle 7 acting in the opening direction predominate, the first nozzle needle 7 lifts away from the first sealing seat 12 so that the at least one first injection orifice 3 communicates with the nozzle chamber 26 and can therefore inject fuel into the combustion chamber/premixing chamber 5. The stroke movement 67 of the control piston 61 is dimensioned so that the opening movement of the first nozzle needle 7 does not exceed the preliminary stroke 24.

If an additional injection of fuel by means of the at least one second injection orifice 4 is desired, then the actuator is triggered so that the control piston 61 executes an additional stroke motion. In reaction to this, the first nozzle needle 7 lifts further away from the first sealing seat 12 so that its opening movement exceeds the predetermined preliminary stroke 24. As a result, the catch contours 19, 20 engage with each other so that the first nozzle needle 7 carries the second nozzle needle 9 along with it during its further stroke motion. The catch-induced motion of the second nozzle needle 9 causes it to lift away from the second sealing seat 16 so that the at least one second injection orifice 4 also communicates with the nozzle chamber 26 and can therefore inject fuel into the chamber 5.

To terminate the injection process, the actuator is triggered so that the control piston 61 retracts again, thus reducing the volume in the second booster chamber 59 once more. As a result, the pressure therein increases to approximately the pressure prevailing in the supply line 25. This changes the balance of forces acting on the second nozzle needle 7 again, resulting in a closing force that closes the first nozzle needle 7. At the very latest when the first nozzle needle 7 has closed, the balance of forces acting on the second nozzle needle 9 also changes so that the closing force of the second spring 50 predominates and the second nozzle needle 9 also closes.

In this embodiment form as well, both of the nozzle needles 7, 9 can be controlled with only a single actuator.

It is also of particular significance that the second nozzle needle 9 does not have a pressure shoulder so that the balance of forces acting on it does not change with the opening of the first nozzle needle 7. Furthermore, only relatively low closing forces are required to prestress the second nozzle needle 9 toward its closed position and to keep it closed.

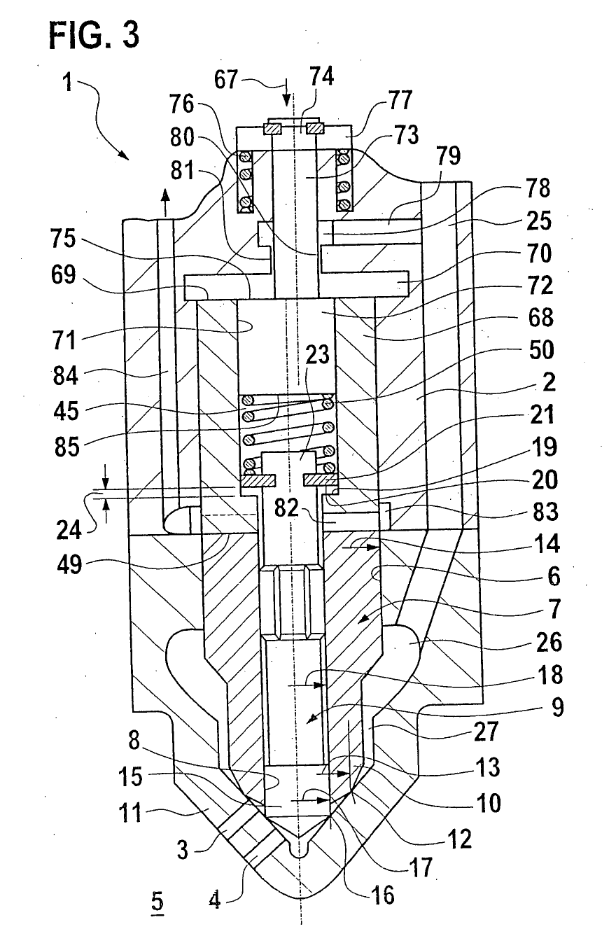

FIG. 3 shows a third exemplary embodiment of the fuel injector 1 according to the present invention. Because there are components and functions that correspond to those in the first two exemplary embodiments, reference is hereby made to the relevant statements regarding FIGS. 1 and 2, so as to limit the discussion below to merely explaining the differences.

As shown in FIG. 3, in this embodiment form as well, a booster piston 68 is provided to drive the first nozzle needle 7 and together with the first nozzle needle 7, constitutes a unit that can be driven into a shared stroke motion. The booster piston 68 has a first surface 69, which is disposed in a control chamber 70 and can be subjected to a pressure therein. The first surface 69 is oriented away from the injection orifices 3, 4 so that it acts in the closing direction when subjected to pressure. The booster piston 68 has a piston guide 71 inside that contains a control piston 72, which is supported so that it can execute a stroke motion. The control piston 72 is disposed coaxially inside the booster piston 68. The control piston 72 is coupled to an actuator 74 via a coupling rod 73 so that the actuator 74 can at least exert compressive forces on the control piston 72 via the coupling rod 73.

The control piston 72 has a control surface 75, which is likewise disposed in the control chamber 70 and can be subjected to a pressure. In addition, a first spring 76 and a second spring 51 drive the control piston 72 in the direction of a reduction of the volume in the control chamber 70. The first spring 76 here is supported between the injector body 2 and a piston 77 that is drive-connected to the actuator 74. If the compression-rigid coupling between the actuator 74, the coupling rod 73, and the control piston 72 can also transmit tensile forces, then the first spring 76 provides a direct prestressing of the control piston 72 in the direction of a volume reduction in the control chamber 70. But if the coupling between the actuator 74, the coupling rod 73, and the control piston 72 cannot transmit tensile forces, then the first spring 76 merely produces a resetting of the actuator 74 and consequently, a pressure-relief of the control piston 72 as a result of which the prestressing of the second spring 51 can act more powerfully in the direction of a volume reduction in the control chamber 70.

In the embodiment form shown here, the fuel injector 1 also has a filling chamber 78, which in this instance, encompasses the coupling rod 73 in an annular fashion. This filling chamber 78 communicates with the supply line 25 via a bore 79. In the stroke direction between the filling chamber 78 and the control chamber 70, a coupling rod guide 80 is provided that guides the coupling rod 73 axially. The control chamber 70 is fed from the filling chamber 78. To this end, a throttle path 81 is provided that is disposed radially between the coupling rod 73 and the coupling rod guide 80; this throttle path 81 connects the control chamber 70 to the filling chamber 78, albeit in a throttled fashion. In a static state or during relatively slow movements, the throttle path 81 permits a pressure compensation to occur between the filling chamber 78 and the control chamber 70 so that the same pressure prevails in the control chamber 70 as in the supply line 25. With rapid, i.e. dynamic movements of the control piston 72, the pressure compensation between the filling chamber 78 and the control chamber 70 via the throttle path 81 cannot occur rapidly enough, which can be used to control the nozzle needles 7, 9.

By contrast with the embodiment forms in FIGS. 1 and 2, in the embodiment form according to FIG. 3, the second spring 51 does not rest directly against the injector body 2, but against the control piston 72 instead. As a result, the second spring 51 on the one hand, prestresses the second nozzle needle 9 into its closed position and on the other hand, prestresses the control piston 72 in the direction of a volume reduction in the control chamber 70. In the embodiment form shown here, the second spring 51 and the catch contours 19, 20 are still contained in the first leakage chamber 45. The first leakage chamber 45 communicates with a second leakage chamber 83 via at least one bore 82. In this embodiment form, not the first leakage chamber 45, but the second leakage chamber 83 communicates with the relatively unpressurized reservoir via a leakage line 84.

The second spring 51 here rests against a supporting end 85 of the control piston 72, which is oriented toward the injection orifices 3, 4 and therefore away from the control surface 75.

The fuel injector 1 according to the present invention in the embodiment form according to FIG. 3 functions as follows:

In the starting position shown in FIG. 3, the same pressure prevails in the control chamber 70 as in the supply line 25. The balance of forces acting on the first nozzle needle 7 is dimensioned so that a resultant force acts in the closing direction.

If an injection is now to be carried out by means of the at least one first injection orifice 3, then the actuator 74 is triggered to execute a stroke motion in accordance with the arrow 67. The coupling rod 73 transmits the stroke of the actuator 74 to produce a stroke of the control piston 72. The stroke of the control piston 72 produces a movement of the control surface 75, which causes the volume of the control chamber 70 to increase. Because this volume change occurs very rapidly, fuel cannot flow through the throttle path 81 rapidly enough, resulting in an underpressure in the control chamber 70. The pressure decrease in the control chamber 70 changes the balance of forces acting on the first nozzle needle 7 in such a way that the forces acting on the pressure shoulder of the first nozzle needle 7 in the opening direction now predominate. This produces a resultant force in the opening direction on the first nozzle needle 7 so that the first nozzle needle 7 lifts away from the first sealing seat 12. As a result, the at least one first injection orifice 3 communicates with the nozzle chamber 26 and can inject fuel into the chamber 5. As long as the fuel injection is to be executed only by means of the at least one first injection orifice 3, the actuation of the actuator 74 and the triggering of the control piston 72 are executed so that the opening stroke of the first nozzle needle 7 is smaller than the predetermined preliminary stroke 24.

If more fuel per unit time then needs to be injected into the chamber 5, it can be necessary to also inject fuel into the combustion chamber 5 by means of the at least one second injection orifice 4. In order to make this possible, the actuator 74 is triggered to execute a further stroke motion so that the control piston 72 coupled to it also executes a further stroke motion. This causes the first nozzle needle 7 to lift even farther away from the first sealing seat, thus exceeding the predetermined preliminary stroke 24. This once again causes the desired cooperation of the two catch contours 19, 20 so that the opening stroke of the second nozzle needle 7 exceeding the preliminary stroke 24 brings the first nozzle needle 9 along with it. As a result, the second nozzle needle 9 lifts away from the second sealing seat 16, which causes the at least one second injection orifice 4 to also communicate with the nozzle chamber 26 so that it can also inject fuel into the chamber 5.

To terminate the injection process, the actuator 74 is triggered to retract the control piston 72, which can be assisted by the first spring 76. At the same time, the second spring 51 also assists the return movement of the control piston 72. The second spring 51 simultaneously drives the second nozzle needle 9 into its closed position.

In this embodiment form as well, it is possible to provide only a single actuator 74, which can, as needed, trigger only the first nozzle needle 7 to open or can trigger the first nozzle needle 7 to open first, followed by the second nozzle needle 9.

1-13. (canceled)

14. A fuel injector for an internal combustion engine, comprising
an injector body (2), which has at least one first injection orifice (3) and at least one second injection orifice (4),
a first nozzle needle (7) that is embodied as a hollow needle and is guided in a first needle guide (6) of the injector body (2),
a second nozzle needle (9) disposed coaxial to the first nozzle needle (7),
the first nozzle needle (7) being driven to control the injection of fuel through the at least one first injection orifice (3) and the second nozzle needle (9) being driven to control the injection of fuel through the at least one second injection orifice (4),
a first catch contour (19) embodied on the first nozzle needle (7) and
a second catch contour (20) embodied on the second nozzle needle (9), whereby once the first nozzle needle (7) opens a predetermined preliminary stroke (24), the first catch contour (19) cooperates with the second catch contour (20) and when an opening movement of the first nozzle needle (7) exceeds the preliminary stroke (24), carries the second nozzle needle (9) along with it.

15. The fuel injector according to claim 14, further comprising a first leakage chamber (45) and wherein the catch contours (19, 20) cooperate with each other in the first leakage chamber (45).

16. The fuel injector according to claim 14, wherein the second nozzle needle (9) does not have a pressure shoulder.

17. The fuel injector according to claim 15, wherein the second nozzle needle (9) does not have a pressure shoulder.

18. The fuel injector according to claim 14, wherein further comprising drive means driving the first nozzle (7), the drive means including
a compensation chamber (30)
a first control chamber (34)
a second control chamber (36) communicating with the first control chamber (34)
a booster piston (28) having a first surface (29) in the compensator chamber (30) that acts in the closing direction when subjected to pressure and a second surface (33) that acts in the opening direction when subjected to pressure,
a supply line (25) that supplies highly pressurized fuel to the injection orifices (3, 4), the compensation chamber (30) communicating with the supply line (25), and
an actuating piston (38) having a third surface (37) in the second control chamber (36).

19. The fuel injector according to claim 15, wherein further comprising drive means driving the first nozzle (7), the drive means including
a compensation chamber (30)
a first control chamber (34)
a second control chamber (36) communicating with the first control chamber (34)
a booster piston (28) having a first surface (29) in the compensator chamber (30) that acts in the closing direction when subjected to pressure and a second surface (33) that acts in the opening direction when subjected to pressure,
a supply line (25) that supplies highly pressurized fuel to the injection orifices (3, 4), the compensation chamber (30) communicating with the supply line (25), and
an actuating piston (38) having a third surface (37) in the second control chamber (36).

20. The fuel injector according to claim 18, wherein
the booster piston (28) and the first needle (7) constitute a unit that is driven into a shared stroke motion, and wherein
the first catch contour (19) is provided on the booster piston (28).

21. The fuel injector according to claim 14, further comprising means driving the nozzle needle (7), including a booster piston (51) having a first surface (52) in a first booster chamber (53), the first surface (52) that acting in the closing direction when subjected to pressure,
a second leakage chamber (55), and
a first spring (54) in the second leakage chamber (55) and pressing the booster piston in the opening direction.

22. The fuel injector according to claim 21, wherein the booster piston (51), comprising at least one bore (57) via which the second leakage chamber (55) communicates with the first leakage chamber (45).

23. The fuel injector according to claim 21, further comprising
a control piston (61) having a forward stroke surface (62) in a control chamber (63) and the return stroke surface (60) in a second booster chamber (59),
the control chamber (63) communicating with a supply line (25) that supplies highly pressurized fuel to the injection orifices (3, 4),
the return stroke surface (60) and the forward stroke surface (62) being disposed at opposite ends of the control piston (61),
the control piston (61) separating the control chamber (63) from the second booster chamber (59), and
the first booster chamber (53) communicating with the second booster chamber (59).

24. The fuel injector according to claim 22, further comprising
a control piston (61) having a forward stroke surface (62) in a control chamber (63) and the return stroke surface (60) in a second booster chamber (59),
the control chamber (63) communicating with a supply line (25) that supplies highly pressurized fuel to the injection orifices (3, 4),
the return stroke surface (60) and the forward stroke surface (62) being disposed at opposite ends of the control piston (61),
the control piston (61) separating the control chamber (63) from the second booster chamber (59), and
the first booster chamber (53) communicating with the second booster chamber (59).

25. The fuel injector according to claim 21, wherein the control chamber (63) communicates with the second booster chamber (59) via a throttle path (66).

26. The fuel injector according to claim 22, wherein the control chamber (63) communicates with the second booster chamber (59) via a throttle path (66).

27. The fuel injector according to claim 23, wherein the control chamber (63) communicates with the second booster chamber (59) via a throttle path (66).

28. A fuel injector according to claim 14, further comprising a booster piston (68) for driving the first nozzle needle (7), the booster piston (68) having a first surface (69) in a control chamber (70), the first surface (69) acting in the closing direction when subjected to pressure, and
a control piston (72) having a control surface (75) in the control chamber (70) and is driven by an actuator (74) to enlarge the volume in the control chamber (70).

29. The fuel injector according to claim 28, wherein the control piston (72) is guided coaxially inside the booster piston (68).

30. The fuel injector according to claim 28, wherein
the control chamber (70) is supplied from a filling chamber (78) that communicates with a supply line (25) that supplies highly pressurized fuel to the injection orifices (3, 4), and wherein the control chamber (70) communicates with the filling chamber (78) via a throttle path (81).

31. The fuel injector according to claim 29, wherein
the control chamber (70) is supplied from a filling chamber (78) that communicates with a supply line (25) that supplies highly pressurized fuel to the injection orifices (3, 4), and wherein the control chamber (70) communicates with the filling chamber (78) via a throttle path (81).

32. The fuel injector according to claim 28, wherein the second nozzle needle (9) is prestressed in the closing direction by a second spring (50), one end of which rests against the second nozzle needle (9) the other end of which rests against a supporting end (85) of the control piston (72) oriented away from the control surface (75).

33. The fuel injector according to claim 30, wherein the second nozzle needle (9) is prestressed in the closing direction by a second spring (50), one end of which rests against the second nozzle needle (9) the other end of which rests against a supporting end (85) of the control piston (72) oriented away from the control surface (75).
